(19) United States
(12) Patent Application Publication
(10) Pub. No.: US 2026/0370791 A1
(43) Pub. Date: Nov. 19, 2026

(54) IMAGE PROCESSING APPARATUS AND CONTROL METHOD

(71) Applicant: CANON KABUSHIKI KAISHA, Tokyo (JP)

(72) Inventor: Naoki TSUKABE, Kanagawa (JP)

(21) Appl. No.: 19/671,305

(22) Filed: May 8, 2026

(30) Foreign Application Priority Data
May 15, 2025 (JP) 2025-082123

(51) Int. Cl. H04N 13/271; H04N 13/00; H04N 13/296; H04N 23/63

(52) U.S. Cl. CPC H04N 13/271; H04N 13/296; H04N 23/632; H04N 23/634; H04N 23/635; H04N 2013/0081; H04N 2013/0096

(57) ABSTRACT

An image processing apparatus detects a subject in an image, acquires distance information of the detected subject, obtains a blur amount of the detected subject based on an image capture condition of the image and the distance information, and determines, as a focus position, a position between a first subject and a second subject farther than the first subject, at which a blur amount of the first subject is larger than a blur amount of the second subject.

### BACKGROUND

### Field of the Technology

The present disclosure relates to a technical field of determining an image capture condition of an image suitable for three-dimensional modeling.

### Description of the Related Art

There is known three-dimensional modeling for generating three-dimensional data representing an object in a three-dimensional space based on a captured image. There is also known a technique of generating a virtual viewpoint image of a viewpoint different from that of a captured image by drawing three-dimensional data at an arbitrary viewpoint (virtual viewpoint) in a three-dimensional space.

Japanese Patent Laid-Open No. 2017-157239 describes a method of generating an image in which each subject is in focus, by setting an in-focus range in image data that can generate a refocused image.

In three-dimensional modeling, when generating three-dimensional data of each subject in an image, it may be desirable to capture an image so that the qualities of the textures of the three-dimensional data of the respective subjects are equal. For example, for a commemorative photo obtained by capturing subjects having a front-to-rear relationship, if one subject is in focus, another subject is significantly out of focus, thereby degrading the quality of the texture. Even if image capture is performed so that the blur amounts of the subjects on the front and rear sides are equal, the quality of the texture of the subject on the rear side deteriorates due to an image capture magnification, as compared with the subject on the front side. Since the quality of the texture depends on the image capture condition of the image, it is important to determine an optimum image capture condition.

In Japanese Patent Laid-Open No. 2017-157239, an image is generated from image data that can be refocused, and thus it is not described that such image capture condition is determined that the textures of three-dimensional data are equal for a plurality of subjects.

### SUMMARY

The present disclosure has been made in consideration of the aforementioned problems, and provides technical advantages in determining such image capture condition that the qualities of the textures of the three-dimensional data of subjects in an image are equal.

In order to solve the aforementioned problems, the present disclosure is directed to an image processing apparatus comprising: at least one processor; and at least one memory which stores a program which, when executed by the at least one processor, causes the image processing apparatus to function as: a detection unit that detects a subject in an image; an acquisition unit that acquires distance information of the detected subject; and a determination unit that obtains a blur amount of the detected subject based on an image capture condition of the image and the distance information, and determines, as a focus position, a position between a first subject and a second subject farther than the first subject, at which a blur amount of the first subject is larger than a blur amount of the second subject.

According to the present disclosure, it is possible to determine such image capture condition that the qualities of the textures of the three-dimensional data of subjects in an image are equal.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram exemplifying an apparatus configuration according to a present embodiment;

FIGS. 2A and 2B are views exemplifying the configuration of an imaging unit according to the present embodiment;

FIGS. 3A to 3E are views illustrating a distance measurement method using an imaging plane phase difference detection method according to the present embodiment;

FIG. 4 is a flowchart exemplifying control processing in a three-dimensional mode according to the present embodiment; and

FIG. 5 is a view exemplifying a user interface in the three-dimensional mode according to the present embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

The present embodiment will describe an example in which an image processing apparatus and an image capture apparatus are applied to a digital camera and the digital camera determines a focus position from the blur amount of each subject based on depth information representing the distance distribution of each subject. Note that the present embodiment is not limited to the digital camera, and is applicable to various apparatuses each of which acquires the depth information of each subject in an image and determines a focus position from a blur amount based on the depth information. Furthermore, in the present embodiment, for example, an image capture apparatus and an image processing apparatus may be configured separately like a form in which a digital camera as an image capture apparatus and a smartphone or general-purpose computer (PC) as an image processing apparatus are connected.

### Apparatus Configuration

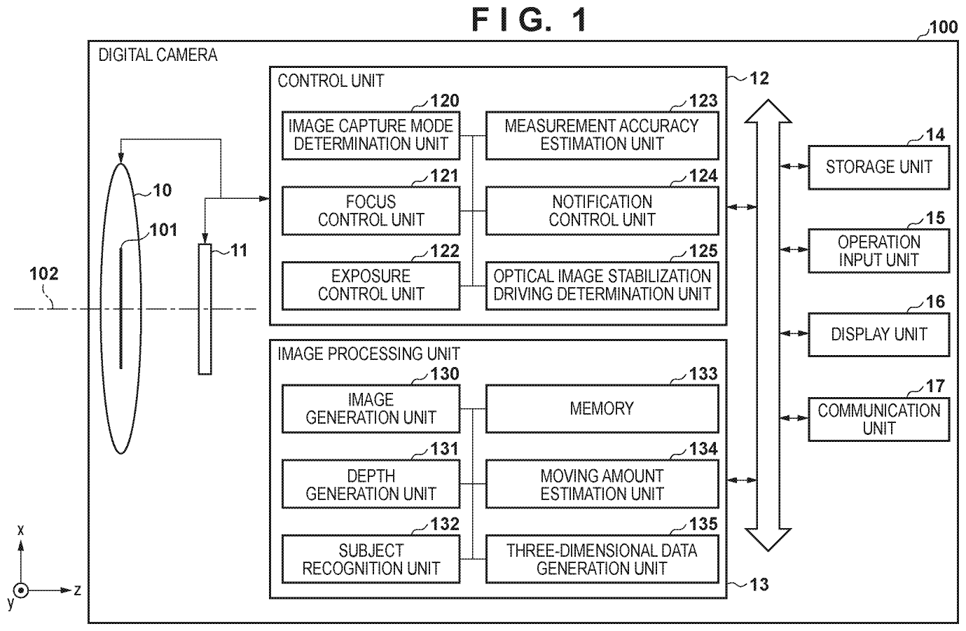

FIG. 1 is a block diagram exemplifying the configuration of a digital camera 100 according to the present embodiment.

An image capture optical system 10 includes a lens group incorporated in th digital camera 100 or an interchangeable lens attachable to a camera main body unit, and forms an optical image of a subject on the imaging surface of an imaging unit 11. The image capture optical system 10 includes a plurality of lenses (not shown) arranged on an optical axis 102, and includes an exit pupil 101 at a position apart from the imaging unit 11 by a predetermined distance. Note that in the present embodiment, a direction parallel to the optical axis 102 is defined as the z direction (depth direction). That is, the depth direction is a direction in which a subject exists with reference to the position of the digital camera 100. In addition, a direction orthogonal to the optical axis 102 and parallel to the horizontal direction of the imaging unit 11 is defined as the x direction, and a direction orthogonal to the optical axis 102 and parallel to the vertical direction of the imaging unit 11 is defined as the y direction.

The imaging unit 11 is, for example, a Charge-Coupled Device (CCD) image sensor or a Complementary Metal Oxide Semiconductor (CMOS) image sensor. The imaging unit 11 performs photoelectric conversion on a subject image formed on the imaging surface via the image capture optical system 10, and outputs an image signal associated with the subject image. The imaging unit 11 has a distance measurement (detection) function using the imaging plane phase difference method as will be described later, and can generate and output distance information indicating the distance (subject distance) from the front focal position of the digital camera 100 to the subject in focus in addition to a captured image.

A control unit 12 includes a Central Processing Unit (CPU) or a microprocessor, a ROM storing a control program, and a RAM serving as a main memory, and controls the respective components of the digital camera 100. In the present embodiment, the control unit 12 includes an image capture mode determination unit 120, a focus control unit 121, an exposure control unit 122, a measurement accuracy estimation unit 123, a notification control unit 124, and an optical image stabilization driving determination unit 125. The optical image stabilization is also expressed as OIS. The control unit 12 controls an image processing unit 13, a storage unit 14, an operation input unit 15, a display unit 16, and a communication unit 17 via a bus.

The image capture mode determination unit 120 determines the image capture mode of the digital camera 100. The image capture mode includes, for example, a mode (normal image capture mode) of performing normal image capture and a mode (three-dimensional mode) of performing image capture for generating three-dimensional data. When the image capture mode determination unit 120 determines that the image capture mode is the three-dimensional mode, it may further determine which of a plurality of three-dimensional modes is set, and execute processing of, for example, limiting the image capture condition in accordance with a determination result.

The focus control unit 121 executes control for focusing on a control target subject based on the distance information of the subject. The focus control unit 121 calculates the distance information of the subject based on the position information of a focusing lens and the optical design information of the image capture optical system 10 in focus control.

The exposure control unit 122 calculates an optimum exposure condition based on the image capture condition set in accordance with the image capture mode, and sets image capture parameters such as the sensitivity, f-number, and exposure time.

The measurement accuracy estimation unit 123 estimates an error (measurement accuracy) that may occur in a distance measurement result, based on the set or calculated focal length, subject distance, sensitivity, f-number, and exposure time. When the estimated error exceeds a preset error range, the measurement accuracy estimation unit 123 calculates such recommended image capture condition that the error falls within a desired range.

The notification control unit 124 displays the estimated error of the distance, the recommended image capture condition, the setting values of the image capture parameters, and the like on the display unit 16, thereby notifying the user of them.

The optical image stabilization driving determination unit 125 confirms the position of an image stabilized lens driven by optical image stabilization in the image capture mode, and estimates a field curvature corresponding to the position of the image stabilized lens. Then, the optical image stabilization driving determination unit 125 determines whether the driving amount of the image stabilized lens reaches a driving amount with which the field curvature is larger than a predetermined amount.

The optical image stabilization driving determination unit 125 acquires data recording a state in which the image stabilized lens is driven during exposure in a case where optical image stabilization is executed in the image capture mode. In particular, the optical image stabilization driving determination unit 125 acquires information of the average driving position of the image stabilized lens during exposure. The optical image stabilization driving determination unit 125 records in advance, based on the design value of the image capture optical system 10, information indicating a state in which the field curvature changes depending on the driving position of the image stabilized lens, and calculates the field curvature corresponding to the acquired average driving position. Distance measurement error correction by a field curvature is executed based on the calculated field curvature at the time of generating a depth image.

Furthermore, in a case where, for example, the field curvature is larger than the predetermined amount, it is impossible to sufficiently obtain the effect of correction, and thus the optical image stabilization driving determination unit 125 sets a limit driving amount in accordance with the image capture optical system 10 and a desired measurement error amount. Then, when the image stabilized lens is driven by exceeding the limit driving amount, the optical image stabilization driving determination unit 125 determines that the measurement error becomes large. When the optical image stabilization driving amount is large and its influence on the measurement accuracy is nonnegligible, the user is notified of lowering in measurement accuracy and recommendation for performing image capture again.

The image processing unit 13 executes various kinds of image processes on the image signal output from the imaging unit 11. The image processing unit 13 includes an image generation unit 130, a depth generation unit 131, a subject recognition unit 132, a moving amount estimation unit 134, and a three-dimensional data generation unit 135. In addition, the image processing unit 13 includes a volatile memory 133 used as a work area for the image processing. Note that the function of the image processing unit 13 may be formed by a logic circuit or by a CPU and a memory storing an arithmetic processing program.

The image generation unit 130 performs, on the image signal output from the imaging unit 11, various kinds of signal processes such as noise reduction, demosaicing, luminance signal conversion, aberration correction, white balance adjustment, and color correction, thereby generating an image for viewing. The image data processed by the image generation unit 130 is stored in the memory 133.

The depth generation unit 131 generates a depth image (depth map) indicating the depth distribution of the subject in the image based on an image signal obtained by a distance measurement pixel of the imaging unit 11. In the depth image, a value indicated by each pixel represents the distance of the subject existing in a region of the image corresponding to the pixel.

The subject recognition unit 132 recognizes the region of the subject in the image. In this case, a user operation may be accepted via the operation input unit 15 to recognize the subject more matching the user's intention.

The moving amount estimation unit 134 estimates, from time-series image data, the moving amount of the subject recognized by the subject recognition unit 132. The moving amount of the subject is estimated as a relative moving amount with respect to the digital camera 100 using an Inertial Measurement Unit (IMU) (not shown) incorporated in the digital camera 100, known Visual SLAM, or the like.

The three-dimensional data generation unit 135 executes three-dimensional modeling for generating three-dimensional data based on the image data generated by the image generation unit 130, the depth image generated by the depth generation unit 131, and the subject region recognized by the subject recognition unit 132.

The control unit 12, the image processing unit 13, the storage unit 14, the operation input unit 15, the display unit 16, and the communication unit 17 are connected to the bus to be able to exchange data.

The storage unit 14 includes a nonvolatile storage medium. For example, captured image data, intermediate data generated in the processing of each unit of the digital camera 100, parameters referred to in the operation of the image processing unit 13 or the digital camera 100, and the like are stored in the storage unit 14. The storage unit 14 need only have a function that ensures acceptable processing performance to implement the processing. A mass storage medium for which a read/write operation can be performed at a high speed may be used, and a flash memory or the like is used.

The operation input unit 15 includes an input device that accepts a user operation. The input device includes dials, buttons, switches, and a touch panel, detects an information input operation, a setting change operation, or the like for the digital camera 100, and outputs a detection signal corresponding to the user operation to the control unit 12.

The display unit 16 includes a display device such as a liquid crystal display or an organic electro-luminescence (EL) display. The display unit 16 displays a live view image, confirms the composition at the time of image capture, displays various kinds of setting screens, and displays a message. Furthermore, the display unit 16 displays information output from the notification control unit 124 of the control unit 12. In a case where a touch panel is used, the display unit 16 can have a display function and an input function.

The communication unit 17 serves as an interface for transmitting/receiving information between the digital camera 100 and an external apparatus. The communication unit 17 can transmit, to the external apparatus, acquired image data, a depth image, coordinate information, and the like.

The functions of the control unit 12 and the image processing unit 13 are implemented by the hardware and/or software of the digital camera 100.

### Configuration of Imaging Unit 11

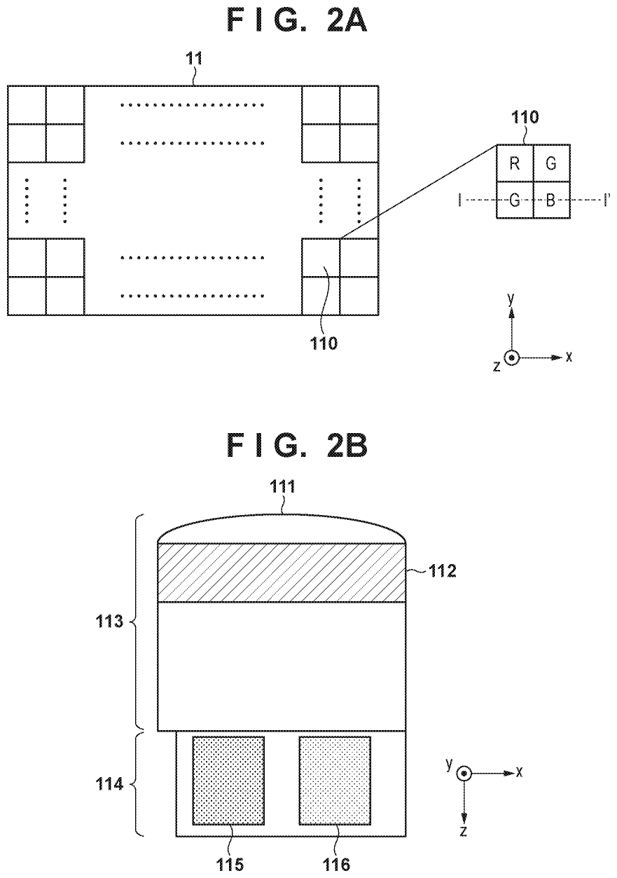

The configuration of the imaging unit 11 will be described next with reference to FIGS. 2A and 2B.

FIG. 2A is a schematic view exemplifying the arrangement of a pixel group. A direction perpendicular to the sheet surface of FIG. 2A is defined as the z direction and two directions orthogonal to each other within the sheet surface are defined as the x direction and the y direction. FIG. 2B is a schematic view exemplifying the configuration of a unit pixel. A direction perpendicular to the sheet surface of FIG. 2B is defined as the y direction and two directions orthogonal to each other within the sheet surface of FIG. 2B are defined as the x direction and the z direction.

Referring to FIG. 2A, the imaging unit 11 includes a pixel group obtained by two-dimensionally arraying a plurality of pixel portions 110. Each pixel portion 110 consists of two rows and two columns in which different color filters are arranged. As shown enlarged in FIG. 2A, in the pixel portion 110, a color filter of one of red (R), green (G), and blue (B) is arranged and an image signal corresponding to color information of one of R, G, and B is output from a photoelectric conversion element forming the pixel portion 110. Note that FIG. 2A shows an example in which an R color filter is arranged in the upper left pixel, a B color filter is arranged in the lower right pixel, and a G color filter is arranged in each of the lower left and upper right pixels, but the present disclosure is not limited to the example shown in FIG. 2A.

The imaging unit 11 has the distance measurement function using the imaging plane phase difference method. FIG. 2B exemplifies a sectional view of a unit pixel corresponding to a section taken along a line I-I′ in FIG. 2A.

The unit pixel includes a light guide layer 113 including a microlens 111 and a color filter 112, and a light receiving layer 114 including a first photoelectric conversion portion 115 and a second photoelectric conversion portion 116. In the light guide layer 113, the microlens 111 efficiently guides incident light to the first photoelectric conversion portion 115 and the second photoelectric conversion portion 116. The color filter 112 transmits light in a predetermined wavelength band. The color filter 112 transmits only light in a wavelength band corresponding to one of R, G, and B, and guides the light to the first photoelectric conversion portion 115 and the second photoelectric conversion portion 116 of the succeeding stage.

The light receiving layer 114 is provided with the first photoelectric conversion portion 115 and the second photoelectric conversion portion 116. Each of the first photoelectric conversion portion 115 and the second photoelectric conversion portion 116 photoelectrically converts the received light into an analog image signal and outputs it. The two kinds of signals respectively output from the first photoelectric conversion portion 115 and the second photoelectric conversion portion 116 are used in distance measurement. In distance measurement, among the first photoelectric conversion portion 115 and the second photoelectric conversion portion 116 arranged in a predetermined direction (horizontal direction) in the imaging unit 11, the image signal formed by the signal output from the first photoelectric conversion portion 115 is used as an A image signal and the image signal formed by the signal output from the second photoelectric conversion portion 116 is used as a B image signal. It is possible to acquire depth information or distance information from the phase difference between the A image signal and the B image signal. That is, each of the first photoelectric conversion portion 115 and the second photoelectric conversion portion 116 partially receives a light beam entering via the microlens 111. The A image signal and the B image signal are signals of pupil division images associated with light beams passing through different pupil partial regions of the exit pupil 101 of the image capture optical system 10. In each pixel portion 110, an image signal (so-called added image signal) obtained by photoelectric conversion by both the first photoelectric conversion portion 115 and the second photoelectric conversion portion 116 is used as a captured image. That is, a signal obtained by compositing the A image signal and the B image signal is equivalent to a viewing image signal output from a single photoelectric conversion portion in a case where a unit pixel includes only one photoelectric conversion portion.

The imaging unit 11 according to the present embodiment can output the image signal for viewing, and the A image signal and the B image signal (pupil division images) for distance measurement. Each of all the pixel portions of the imaging unit 11 includes a plurality of photoelectric conversion portions, and it is thus possible to acquire high-density depth information. Note that FIG. 2B shows an example in which two photoelectric conversion portions are arrayed in one pixel. However, the present disclosure is not limited to the example shown in FIG. 2B, and three or more photoelectric conversion portions may be provided in one pixel.

### Distance Measurement Method

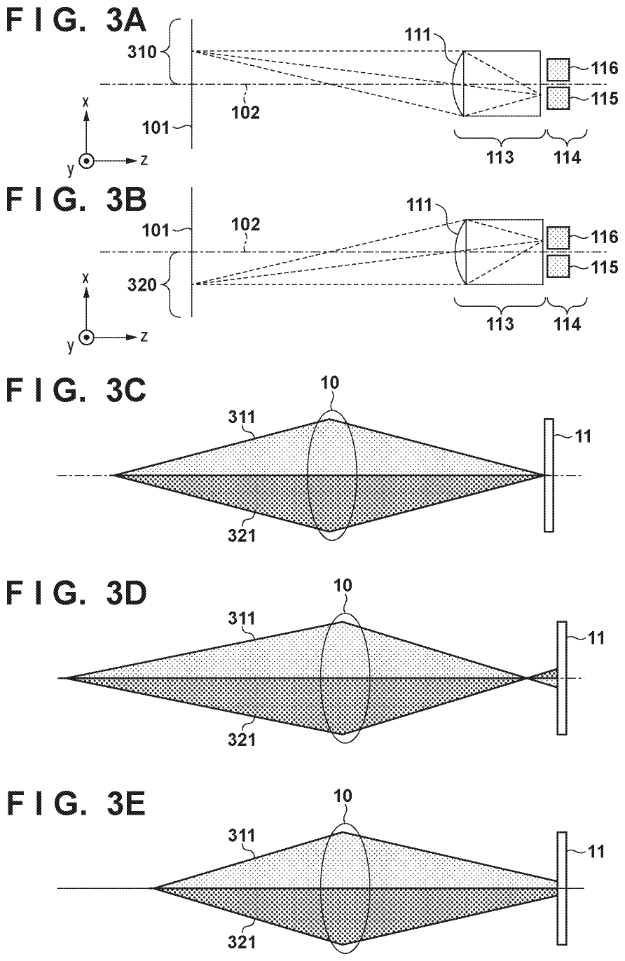

A distance measurement (detection) method using the imaging plane phase difference method will be described next with reference to FIGS. 3A to 3E.

In the distance measurement method using the imaging plane phase difference method, it is possible to calculate a subject distance based on the A image signal and the B image signal (signals of pupil division images) output from the first photoelectric conversion portion 115 and the second photoelectric conversion portion 116.

FIG. 3A is a schematic view exemplifying the relationship between the exit pupil 101 of the image capture optical system 10 and a light beam received by the first photoelectric conversion portion 115. FIG. 3B is a schematic view exemplifying the relationship between the exit pupil 101 of the image capture optical system 10 and a light beam received by the second photoelectric conversion portion 116. In FIGS. 3A and 3B, a direction perpendicular to the sheet surface is defined as the y direction and two directions orthogonal to each other within the sheet surface are defined as the x direction and the z direction.

The microlens 111 exemplified in FIGS. 3A and 3B is arranged so that the exit pupil 101 and the light receiving layer 114 have an optically conjugate relationship. A light beam having passed through the exit pupil 101 of the image capture optical system 10 is condensed by the microlens 111 and guided to the first photoelectric conversion portion 115 or the second photoelectric conversion portion 116. In this case, the first photoelectric conversion portion 115 and the second photoelectric conversion portion 116 mainly receive light beams having passed through the different pupil partial regions, respectively, as shown in FIGS. 3A and 3B. The first p hotoelectric conversion portion 115 receives light having passed through a first pupil partial region 310, and the second photoelectric conversion portion 116 receives light having passed through a second pupil partial region 320.

Each of the plurality of first photoelectric conversion portions 115 of the imaging unit 11 outputs a first image signal corresponding to the A image signal. Each of the plurality of second photoelectric conversion portions 116 of the imaging unit 11 outputs a second image signal corresponding to the B image signal. It is possible to acquire, from the first image signal, the intensity distribution of an image formed on the imaging surface of the imaging unit 11 by the light having passed through the first pupil partial region 310. Furthermore, it is possible to acquire, from the second image signal, the intensity distribution of an image formed on the imaging surface of the imaging unit 11 by the light having passed through the second pupil partial region 320. The relative positional deviation amount (parallax amount) between the first image signal and the second image signal has a magnitude according to a defocus amount.

The relationship between the parallax amount and the defocus amount will be described with reference to FIGS. 3C, 3D, and 3E.

FIGS. 3C, 3D, and 3E exemplify a first light beam 311 that passes through th first pupil partial region 310 and a second light beam 321 that passes through the second pupil partial region 320. FIG. 3C shows an in-focus state, in which the first light beam 311 and the second light beam 321 are converged on the light receiving surface of the imaging unit 11. In this case, the parallax amount between the first image signal and the second image signal is zero.

FIG. 3D shows a defocus state in which the focal point is in the negative direction (left direction) of the z-axis (optical axis) on the image side. The parallax amount between the first image signal and the second image signal is a negative value. FIG. 3E shows a defocus state in which the focal point is in the positive direction of the z-axis on the image side. The parallax amount between the first image signal and the second image signal is a positive value. By comparing FIGS. 3D and 3E with each other, it is apparent that the direction (defocus direction) of the positional deviation is reversed in accordance with whether the defocus amount is positive or negative. It is also apparent that depending on the defocus amount, the positional deviation occurs according to the imaging relationship (geometric optical relationship) of the image capture optical system 10. It is possible to detect the parallax amount corresponding to the positional deviation between the first image signal and the second image signal by a region-based matching method.

The relationship between an image capture condition and a distance measurement resolution will now be described.

A base-line length W in the imaging plane phase difference method corresponds to the distance between the centroids of the light amount distributions of the light beams in the exit pupil obtained by triangulation. The base-line length W changes according to the value of the f-number, and is longest in a case where the aperture is opened and becomes short in a case where the aperture is narrowed. When the aperture size is smaller than a predetermined size, it is impossible to discriminate two images, thereby disabling distance measurement. The f-number (limit value) corresponding to a smallest aperture size with which distance measurement is possible is a value depending on the characteristics of the image capture optical system 10 and the imaging unit 11 and a parallax calculation method, and for example, an f-number of F11 is set as the limit value.

The f-number (base-line length converted f-number) obtained in accordance with the base-line length W is given by F′=f/W where f represents a focal length. When r represents a parallax amount on the imaging surface and s′ represents a focus distance on the image side, a defocus amount def on the image side is obtained by:

def=rs′/(W−r) (1)

Since the unit of the base-line length W is mm and the unit of the parallax amount r is μm, W>>r, thereby obtaining:

def∞rs′/W (2)

At this time, s′∞f can be obtained except for macro photography, thereby obtaining:

def∞rf/W=rF′ (3)

The distance measurement resolution depends on the resolution of detectable defocus, and the resolution of defocus depends on the f-number F′ (base-line length converted f-number) obtained in accordance with a resolution Δr of the parallax r and the base-line length W.

Δdef∞ΔrF′ (4)

Therefore, as the aperture size is larger (the base-line converted f-number smaller), the distance measurement resolution is improved.

Consider conversion from the distance resolution Δdef on the image side into a distance measurement resolution Δd on the object side. When s represents a subject distance, the distance measurement resolution Δd is obtained by:

Δd=Δrs(s−f)/{fW+r(s−f)} (5)

When an image capture magnification β=1/m is set and macro photography is excluded, equation (5) can be approximated by:

Δd∞ΔrF'm2 (6)

As the image capture magnification β is smaller, that is, as the subject distance s is longer in a case where the focal length f is constant, the distance measurement resolution Δd lowers.

When a measurement error Δh is calculated by setting the distance measurement resolution Δd as a desired error range, expression (7) below can be obtained.

Δh(%)∞±mΔrF′/(f±mΔrF′)×100 (7)

It is apparent from expression (7) that when the parallax resolution Δr is assumed to be constant, the measurement error Δh becomes small if a reciprocal m of the image capture magnification β is small, the f-number (F′ value) is small, and the focal length f is long. That is, as the focal length f is longer and the subject distance s is shorter, it is possible to perform measurement more accurately.

Note that instead of the image capture distance and the image capture magnification, the resolution on the object side may be set as an index for measurement accuracy. Using the image capture magnification β and a size c of a unit pixel of the pixel portion 110, a resolution R on the object side is obtained by:

R=c/β (8)

From equation (8), it is possible to acquire the resolution R by dividing the size c of the unit pixel of the imaging unit 11 by the image capture magnification β.

The parallax resolution Δr depends on the parallax calculation method, a window size at the time of calculation, and the like. However, if the parallax calculation method is the same, the parallax resolution Δr depends on the SNR of the image, and thus lowers as the ISO sensitivity is higher. Although the parallax resolution Δr can be expressed as a function of the ISO sensitivity, the error calculation given by expression (7) can also be performed by setting the ISO sensitivity that satisfies a predetermined parallax resolution Δr and regarding it as a constant value. As described above, the parallax resolution Δr depends on the parallax calculation method and the window size but a satisfactory result is obtained by performing image capture at ISO1600 or less. Note that although depending on desired measurement accuracy, it is also possible to perform measurement by increasing the sensitivity to about ISO6400.

As described above, the focal length and the image capture magnification are also related to a measurement error, and the image capture magnification is determined based on the focal length and the subject distance. For a zoom lens, it is possible to set a changeable parameter as the focal length.

Next, the relationship between the image capture condition and the distance measurement range will be described.

When two images between which the parallax is calculated blur, it is difficult to discriminate the two images, thereby degrading the parallax calculation accuracy. Therefore, the distance range within which distance measurement can be performed is related to the depth of field of the image. The depth of field is expressed by a smallest confusion circle δ and an f-number F on the image side, and the distance measurement range is a rang of ±αFδ. Note that α represents a coefficient determined by the parallax calculation method or the like.

As described above, if the image is out of focus, the distance measurement accuracy degrades, and thus the distance measurement range may be determined in a form of ±αFδ. Alternatively, the distance measurement range may be determined based on the desired distance measurement resolution from expression (7).

Next, the depth image generation method by the depth generation unit 131 will be described.

The depth generation unit 131 executes light amount correction processing on the A image signal and the B image signal to correct the light amount balance between the two images. After that, the depth generation unit 131 executes the band limitation by a bandpass filter to remove a component with a low SNR. After that, the depth generation unit 131 derives the parallax amount between the respective pixels of the two images using correlation calculation. As a correlation deriving method, NCC, SSD, SAD, or the like is used. NCC is an abbreviation for “Normalized Cross-Correlation”. SSD is an abbreviation for “Sum of Squared Difference”. SAD is an abbreviation for “Sum of Absolute Difference”. A calculated parallax amount d is converted into a defocus amount by using a predetermined conversion coefficient. The defocus amount corresponds to the distance from the imaging unit 11 to the focal point of the image capture optical system 10. When K represents a predetermined conversion coefficient and ΔL represents a defocus amount, the parallax amount d is converted into the defocus amount ΔL by:

ΔL=K×d (9)

Furthermore, the defocus amount ΔL can be converted into a subject distance using the lens formula in geometric optics, given by:

1/A+1/B=1/f (10)

In equation (10), A represents the distance (subject distance) from the object surface to the principal point of the image capture optical system 10, B represents the distance from the principal point of the image capture optical system 10 to the imaging surface, and f represents the focal length of the image capture optical system 10. In equation (10), since the value of B can be derived from the defocus amount ΔL, the distance A can be derived based on the setting of the focal length f at the time of image capture.

The exposure control unit 122 performs automatic setting by balancing the distance measurement resolution, the distance measurement range, the shutter speed (exposure time), and the ISO sensitivity at the subject distance and the focal length at the time of image capture. In consideration of the distance measurement resolution and the distance measurement range, for example, the f-number is set around F4, the ISO sensitivity is set around 400, and the shutter speed is finally set to achieve proper exposure. The lower limit of the shutter speed is set to, for example, a speed obtained by adding the number of stops of the image stabilization to (1/focal length). When the shutter speed is lower than the set limit value, the exposure control unit 122 performs adjustment by increasing the setting of the ISO sensitivity to 1600 to achieve proper exposure. Furthermore, in a case where exposure is low, when the f-number can be set to F4 or less, the exposure control unit 122 executes adjustment of the f-number. Although the measurement accuracy may not satisfy desired accuracy depending on the focal length, the subject distance, and the ambient light amount, the exposure control unit 122 adopts the optimum settings under the constraints.

Next, the measurement accuracy estimation method by the measurement accuracy estimation unit 123 will be described.

The measurement accuracy estimation unit 123 estimates the measurement accuracy by expression (7) using the set image capture parameters, the estimated subject distance, and the set focal length in the above-described processing. When the measurement accuracy does not satisfy the required accuracy (predetermined standard), the measurement accuracy estimation unit 123 selects a parameter that can be changed in accordance with a distance measurement mode, and determines whether there exists such setting that the measurement accuracy satisfies the desired accuracy (is equal to or higher than a predetermined threshold) when the parameter is changed. When there exists such setting that the measurement accuracy satisfies the desired accuracy, the measurement accuracy estimation unit 123 changes the image capture parameter to such setting that the measurement accuracy satisfies the desired accuracy. Each of the f-number, the ISO sensitivity, and the shutter speed is set within a limit value range suitable for measurement so as to achieve proper exposure. When a setting value within the limit value range of each parameter is used, an optimum exposure condition may not be obtained, and thus the measurement accuracy estimation unit 123 also determines whether the optimum exposure condition is satisfied. Note that a configuration in which whether to prioritize the setting for satisfying the optimum exposure condition for a viewing image or the setting for distance measurement can be selected as an additional setting and recommended values are calculated in accordance with this setting may be adopted. After determining the f-number, ISO sensitivity, and shutter speed optimum for distance measurement, the measurement accuracy estimation unit 123 calculates a combination of the focal length and the subject distance such that the measurement accuracy satisfies the desired condition. The measurement accuracy estimation unit 123 executes calculation in two cases including a case where the focal length is fixed and a case where the subject distance is fixed. That is, the measurement accuracy estimation unit 123 calculates the subject distance that satisfies the desired measurement accuracy at the focal length set by the user, and calculates such focal length that the measurement accuracy satisfies the desired accuracy when the subject distance is fixed.

### Control Processing

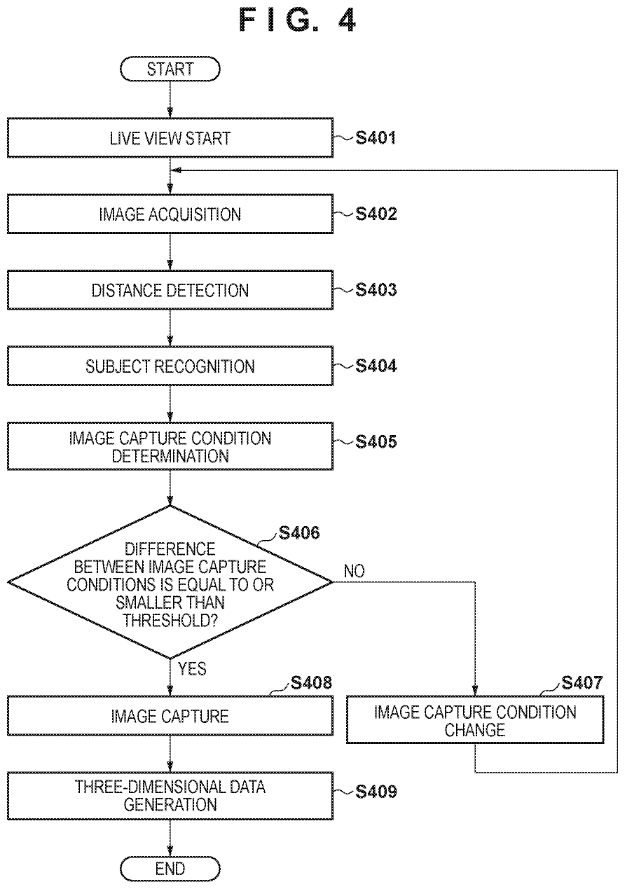

Processing of determining the optimum image capture condition in the three-dimensional mode will be described next with reference to FIG. 4.

FIG. 4 is a flowchart exemplifying processing of determining the optimum image capture condition in the three-dimensional mode.

The processing shown in FIG. 4 is implemented when, for example, the control unit 12 controls the components of the digital camera 100 by reading out the control program stored in the ROM into the RAM and executing it.

The processing shown in FIG. 4 is started when the control unit 12 accepts a user operation on the operation input unit 15 and the image capture mode determination unit 120 detects that the three-dimensional mode is set.

In step S401, the control unit 12 starts a live view. The control unit 12 repeatedly performs processing of generating an image for viewing by processing, by the image generation unit 130, an image signal acquired from the imaging unit 11 and displaying the generated image on the display unit 16, thereby displaying a live view image at a predetermined frame rate on the display unit 16.

In step S402, the control unit 12 acquires an image signal from the imaging unit 11. In the present embodiment, the image signal acquired in the live view in step S401 is used, but an image signal acquired by additionally performing image capture may be used. Image acquisition is performed by opening the aperture during the live view, but image capture may be performed by narrowing the aperture to extend the distance measurement range. This can perform recognition and distance measurement of the subject within a wider range. In the present embodiment, it is possible to narrow the image capture conditions by repeating processes of steps S403 to S407 (to be described later). This can narrow the image capture conditions more accurately than the image capture conditions determined in the previous processing.

In step S403, the control unit 12 causes the image processing unit 13 to generate a depth image from the image signal acquired in step S402, thereby detecting the subject distance. The depth generation unit 131 generates two-dimensional information by setting the subject distance as the pixel values, and stores the depth image based on the two-dimensional information in the memory 133. The depth image generation processing may be executed on the entire image acquired in step S402, or may be speeded up by executing step S404 (to be described later) and limiting a target region based on a recognized subject region.

In step S404, the control unit 12 causes the image processing unit 13 to perform subject recognition on the image signal acquired in step S402. The image generation unit 130 generates one Bayer arrangement image by adding the pixel values of respective pixels of the A image signal and the B image signal in the image signal acquired in step S402, and performs demosaicing processing of an image of each of R, G, and B with respect to the generated Bayer arrangement image, thereby generating an image suitable for subject recognition. In the generated image, the subject recognition unit 132 specifies the region of the subject on the image. To recognize the subject, known face detection by a feature amount may be used, or face detection by machine learning, object detection, segmentation, or Saliency Map estimation method may be used. In addition, the subject recognition accuracy may be improved by using the depth image generated in step S403.

It may be configured to be able to more optimally select a subject intended by the user by accepting a user operation via the operation input unit 15. For example, selection of a plurality of distance measurement modes may be accepted in the three-dimensional mode, and a prioritized subject (human, object, animal, or the like) may be designated, thereby recognizing a subject intended by the user.

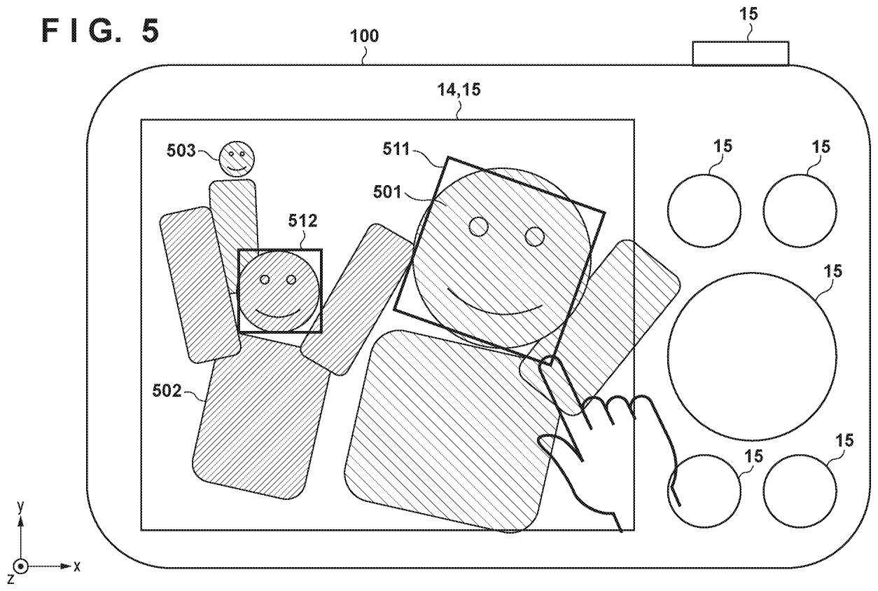

A user interface (UI) during the live view will now be described with reference to FIG. 5.

The present embodiment will describe an example of a status in which a person 501, a person 502, and a person 503 are included in a live view image.

The notification control unit 124 notifies, via the display unit 16, the user of the subject region recognized by the subject recognition unit 132 in step S403. In the example shown in FIG. 5, in a status in which the person 501 and the person 502 are recognized as subjects, the user is notified of the subject regions by superimposing and displaying a rectangular subject recognition result 511 and a rectangular subject recognition result 512 on the person 501 and the person 502 in the live view image, respectively. The notification method is merely an example, and a method of performing semi-transparent superimposition display for another graphic, the subject region, or a region outside the subject region may be adopted.

At this time, the subject recognition unit 132 may accept a user operation via the operation input unit 15, and use it as auxiliary information for subject recognition. For example, in a case where the person 503 is not recognized as a subject, the user may designate the region of the person 503 by a touch operation or the like, thereby accepting an instruction to include the person 503 as a subject within the distance measurement range. Alternatively, in a case where the person 503 is recognized as a subject, the user may designate the region of the person 503 by a touch operation or the like, thereby accepting an instruction to exclude the person 503 from the subjects within the distance measurement range. By providing such UI, the user can select the intended subject region, thereby contributing to determination of the optimum image capture condition. An example of the touch panel has been described as an example of the UI, but the user operation may be a button operation of the operation input unit 15. By allowing the user to select a subject, it is possible to more easily determine the image capture condition intended by the user.

As described above, it is possible to obtain the distance information of each subject in the image acquired in step S402 from the correspondence between the subject region recognized in step S404 and the depth image generated in step S403.

In step S405, the control unit 12 determines the image capture condition. The control unit 12 determines such image capture condition that the distance measurement range is the range within which the subjects exist and the qualities of the textures of the subjects are equal.

First, based on the distance information of each subject obtained in steps S403 and S404, the distance range including the near subject and the distant subject is set as the distance measurement range, thereby determining the image capture condition such that the measurement accuracy of the distance measurement range satisfies the desired accuracy. Thus, it is possible to determine the optimum image capture condition such that the measurement accuracy of the three-dimensional shape of each subject is equal to or higher than a predetermined threshold.

Next, based on the distance information of each subject obtained in steps S403 and S404, a position between the near subject and the distant subject, at which the blur amount of the near subject is larger than that of the distant subject, is determined as a focus position, thereby making it possible to prevent the quality of the texture of the distant subject from being inferior.

More specifically, by determining a focus position such that the blur amounts of the near subject and the distant subject are those according to the image capture magnifications of the subjects, respectively, the qualities of the textures can be made equal when the subjects are displayed at the same size.

The relationship between the blur amount of each subject and the focus position will now be described.

When dist represents the distance between each subject and the front principal point, s1 represents the distance between the focus position and the front principal point, F represents the f-number, and f represents the focal length, the defocus amount def can be given by:

def=dist/(dist/f−1)−1/(1/f−1/s1) (11)

By using the coefficient α, the relationship between the blur amount δ of each subject and the defocus amount def can be given by:

δ=def/αF (12)

From equations (11) and (12), the relationship between the blur amount of each subject and the focus position can be given by:

δ=(dist/(dist/f−1)−1/(1/f−1/s1))/αF (13)

From equation (13), it is possible to determine, as the focus position, a position at which the blur amount of the near subject is larger than that of the distant subject. This can prevent the quality of the texture of the distant subject with the low image capture magnification from being inferior.

More preferably, when δ1 and β1 represent the blur amount and the image capture magnification of the near subject, respectively, and δ2 and β2 represent the blur amount and the image capture magnification of the distant subject, respectively, it is possible to determine the focus position such that the blur amounts of the near subject and the distant subject are those according to the image capture magnifications of the subjects, respectively, by obtaining s1 that satisfies equation (14) below.

δ1+δ2×β2/β1=0 (14)

In a case where the image capture optical system 10 has a characteristic called focus breathing that changes the image capture magnification in accordance with the focus position, the image capture magnification β is calculated as a function β(s1) determined based on the distance s1 between the focus position and the front principal point by measuring or calculating the characteristic in advance. As described above, by determining the focus position based on the change in magnification caused by focus breathing, the digital camera 100 can determine the image capture condition even in the image capture optical system 10 having the focus breathing characteristic.

When three or more subject regions are recognized in step S404, the image capture condition is determined such that the blur amounts of the most distant subject and the nearest subject are those according to the magnifications of the subjects, respectively. Thus, even in a case where a plurality of subjects exist, the texture of the most distant subject whose texture is inferior can be made equal to the texture of the nearest subject.

The image capture condition except for the focus position may be corrected by the measurement accuracy estimation unit 123 and the exposure control unit 122 based on the subject information and the distance information. For example, based on the recognition result and the distance information of the subject, the image capture condition may be determined such that the subject falls within a measurement range that obtains desired distance measurement performance. In this case, the thickness of the subject may be estimated based on the recognition result of the subject, thereby determining the distance measurement range.

For example, in the case of an object whose shape is determined to some extent like the face of a person, it is possible to estimate the position of the eyes or mouth or the thickness of a spherical face in an image. With respect to another object whose shape is determined, it is possible to estimate the thickness of the overall object from an accurately recognized or measured portion. It is possible to accurately determine the distance measurement range by determining the distance measurement range based on the estimated thickness with respect to a region where distance measurement is difficult to be performed or a region that is difficult to enter the visual field, such as the side surface of the object.

In the present embodiment, the two subjects are persons. However, the focus position may be determined by setting the regions of the nose and ear of the face of one person as the near subject and the distant subject, respectively.

In step S406, the control unit 12 makes a determination on the image capture condition. The control unit 12 compares the current image capture condition with the image capture condition calculated in step S405, and determines whether the difference between the image capture conditions is equal to or smaller than a predetermined threshold. When the difference is equal to or smaller than the threshold, the notification control unit 124 notifies the user of it, and the process advances to step S408. When the difference is larger than the threshold, the process advances to step S407.

In step S407, the control unit 12 changes the image capture condition. The control unit 12 notifies the focus control unit 121 of the image capture condition determined in step S405, and changes the focus position. After that, the process returns to the processing of step S402, thereby performing repetitive control until the appropriate focus position is obtained. When the control does not end by one focus position determination operation, the moving amount estimation unit 134 may calculate the relative moving amount of the subject with respect to the digital camera 100 by using the past live view image. When the moving amount of the subject can be calculated, the digital camera 100 can determine, in step S405, the focus position at a high speed by calculating the focus position with respect to an expected future subject position based on a control cycle and the moving amount of the subject.

In step S408, the control unit 12 performs image capture. The control unit 12 stops the live view, causes the image generation unit 130 to convert the image signal acquired from the imaging unit 11 into an image for viewing, and displays the image on the display unit 16. The generated image for viewing and the depth image are stored in the memory 133 or the storage unit 14 for subsequent processing in step S409.

In step S409, the control unit 12 causes the three-dimensional data generation unit 135 to generate three-dimensional data based on the depth image generated in step S403, the subject regions recognized in step S404, and the image for viewing generated in step S408. The three-dimensional data generation unit 135 may generate three-dimensional data in a point cloud format from the xyz data of the depth image and the corresponding image for viewing, or may generate a polygon so as to be easily handled as three-dimensional data. A polygon is generated by defining a surface using pieces of coordinate information of arbitrary three adjacent points in the depth image and calculating texture information of the polygon from the image for viewing.

In this case, the three-dimensional data generation unit 135 may determine a parameter for generating three-dimensional data based on the image capture condition. By generating a model holding necessary and sufficient model information based on the image capture condition, it is possible to generate three-dimensional data that is more lightweight and easily handled.

Especially, it is possible to generate a model with a necessary and sufficient size by determining the density of the shape information of the model and the density of the texture information of the model in accordance with the blur amount of each subject calculated in step S407. For example, a lightweight texture may be generated with reference to a portion with a largest blur amount, or the data size may be reduced without degrading the texture with reference to a portion with a smallest blur amount. Data may be stored with a variable information amount according to the blur amount, as a matter of course. With respect to the shape information as well, it is possible to appropriately reduce the data size in accordance with the purpose by determining the density of the shape information based on the blur amount. In this case, the density of the shape information may be determined in consideration of the measurement accuracy of the shape information by referring to the measurement accuracy of the shape information.

The present embodiment has described an example of an RGBD camera by a pupil division method. The present disclosure is not limited to this example, and various kinds of RGBD cameras such as a stereo camera or a time-of-flight camera may be used.

The present embodiment has described an example of an image processing apparatus that executes three-dimensional modeling. However, the present embodiment may be applied to an image capture apparatus that captures a still image based on an image capture condition, or may display subject regions at the same magnification by directly performing deformation processing on a still image.

As described above, according to the present embodiment, it is possible to determine an image capture condition such that the qualities of the textures of the three-dimensional data of respective subjects in an image are equal.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-082123, filed May 15, 2025 which is hereby incorporated by reference herein in its entirety.

What is claimed is:

1. An image processing apparatus comprising:
at least one processor; and
at least one memory which stores a program which, when executed by the at least one processor, causes the image processing apparatus to function as:
a detection unit that detects a subject in an image;
an acquisition unit that acquires distance information of the detected subject; and
a determination unit that obtains a blur amount of the detected subject based on an image capture condition of the image and the distance information, and determines, as a focus position, a position between a first subject and a second subject farther than the first subject, at which a blur amount of the first subject is larger than a blur amount of the second subject.

2. The apparatus according to claim 1, wherein
the determination unit determines the focus position such that the blur amount of the first subject and the blur amount of the second subject are blur amounts according to image capture magnifications of the subjects, respectively.

3. The apparatus according to claim 2, wherein
in a case where δ represents the blur amount of each subject, dist represents a distance between each subject and a front principal point, s1 represents a distance between the focus position and the front principal point, F represents an f-number, f represents a focal length, and α represents a coefficient, a relationship between the blur amount of each subject and the focus position is given by
δ=(dist/dist/f−1)−1/(1/f−1/s1))/αF

4. The apparatus according to claim 3, wherein
in a case where δ1 represents the blur amount of the first subject, β1 represents the image capture magnification of the first subject, δ2 represents the blur amount of the second subject, and β2 represents the image capture magnification of the second subject, the determination unit determines the focus position such that the blur amount of the first subject and the blur amount of the second subject are blur amounts according to the image capture magnifications of the subjects, respectively, by obtaining the distance s1 between the focus position and the front principal point to satisfy
δ1+δ2×β2/β1=0

5. The apparatus according to claim 1, wherein
the detection unit recognizes a region of a subject in the image, and
the acquisition unit acquires distance information of the recognized subject.

6. The apparatus according to claim 1, wherein
the acquisition unit calculates the distance information of the detected subject based on image signals with a parallax.

7. The apparatus according to claim 6, wherein
the acquisition unit calculates the distance information of the detected subject based on a defocus amount obtained from the image signals with the parallax.

8. The apparatus according to claim 7, wherein
in a case where δ represents the blur amount of the subject, dist represents a distance between the subject and a front principal point, s1 represents a distance between the focus position and the front principal point, F represents an f-number, f represents a focal length, and def represents the defocus amount, the defocus amount is given by
def=dist/(dist/f−1)−1/(1/f−1/s1),
and
a relationship between the blur amount of the subject and the defocus amount is given by
δ =def/αF
where α represents a coefficient.

9. The apparatus according to claim 1, wherein
the determination unit determines the image capture condition based on a change in magnification caused by focus breathing.

10. The apparatus according to claim 1, wherein
in a case where at least three subjects are detected, the acquisition unit selects a nearest subject as the first subject and selects a most distant subject as the second subject.

11. The apparatus according to claim 1, wherein
the determination unit determines the focus position based on a moving amount of the detected subject.

12. The apparatus according to claim 1, wherein
the determination unit determines a distance measurement range based on the detected subject, and determines the image capture condition such that measurement accuracy of the distance measurement range satisfies predetermined accuracy.

13. The apparatus according to claim 12, wherein
the acquisition unit sets the distance measurement range by estimating a thickness of the detected subject, and determines the image capture condition.

14. The apparatus according to claim 1, further comprising:
a user interface unit that accepts a user operation of selecting the first subject and the second subject.

15. The apparatus according to claim 1, further comprising:
a three-dimensional data generation unit that generates three-dimensional data based on the distance information of the detected subject.

16. The apparatus according to claim 15, wherein
the three-dimensional data generation unit determines a parameter for generating three-dimensional data based on the image capture condition.

17. The apparatus according to claim 15, wherein
the three-dimensional data generation unit generates a model for generating three-dimensional data based on the image capture condition.

18. The apparatus according to claim 17, wherein
the three-dimensional data generation unit determines a density of shape information of the model in accordance with the blur amount of the subject.

19. The apparatus according to claim 17, wherein
the three-dimensional data generation unit determines a density of texture information of the model in accordance with the blur amount of the subject.

20. The apparatus according to claim 1, further comprising:
an imaging unit that captures an image via an optical system; and
a control unit that controls the optical system and the imaging unit under image capture condition including the determined focus position.

21. A control method of an image processing apparatus comprising:
detecting a subject in an image;
acquiring distance information of the detected subject;
obtaining a blur amount of the detected subject based on an image capture condition of the image and the distance information; and
determining, as a focus position, a position between a first subject and a second subject farther than the first subject, at which a blur amount of the first subject is larger than a blur amount of the second subject.

22. A non-transitory computer-readable storage medium storing a program for causing a computer to function as an image processing apparatus comprising:
a detection unit that detects a subject in an image;
an acquisition unit that acquires distance information of the detected subject; and
a determination unit that obtains a blur amount of the detected subject based on an image capture condition of the image and the distance information, and determines, as a focus position, a position between a first subject and a second subject farther than the first subject, at which a blur amount of the first subject is larger than a blur amount of the second subject.
